(19) United States
(12) Patent Application Publication
(10) Pub. No.: US 2005/0147799 A1
(43) Pub. Date: Jul. 7, 2005

(54) Article, method of producing and business model for applying a thin laminate sheet of a decorative material

(76) Inventor: Robert Bordener, Bloomfield Hills, MI (US)

Correspondence Address: Douglas J. McEvoy;Gifford, Krass, Groh, Sprinkle,, Anderson & Citkowski, P.C., 280 North Old Woodward - Suite 400, Birmingham, MI, 48009, US

(21) Appl. No.: 11/011,634

(22) Filed: Dec. 14, 2004

Related U.S. Application Data
(63) Continuation-in-part of application No. 10/737,512, filed on Dec. 16, 2003.

(51) Int. Cl. B32B 1/00

(52) U.S. Cl. 428/195.1

(57) ABSTRACT

A flexible and decorative laminate material constructed from an extruded sheet and including a thermoplastic resin base admixed with a volume of a decorative additive, such as compounded granulate. The laminate veneer sheet thus created exhibits at least one substantially transparent viewing surface, combined with an opaque interior and which is capable of being coiled about its least planar dimension to a diameter lesser than the dimension. Typically, the sheet is packaged and shipped to a remote location, prior to being uncoiled, sectioned if necessary, and adhered to a rigid substrate.

### CROSS-REFERENCE TO RELATED APPLICATION

The present application is a continuation-in-part U.S. application Ser. No. 10/737,512 filed Dec. 16, 2003, entitled “Plastic Material with Decorative Attributes”.

### BACKGROUND OF THE INVENTION

1. Field of the Invention

The present invention relates generally to decorative laminate structures and, more specifically, to a thin laminate sheet constructed of an extruded thermoplastic or thermoset resin exhibiting certain inventive decorative optical effects, such as in particular translucent monochrome effects with opaque backer, granule effects, metal effects and the like. The laminate sheet is capable of being coiled or rolled to a diameter considerably less than its lesser planar dimension, conveniently packaged and shipped, and adhered at an end location to a rigid substrate.

2. Description of the Prior Art

The prior art is well documented with examples of extruded and decorative articles. The objective in most instances is to provide an attractive surface for use in various structural applications.

A first example of this is set forth in U.S. Pat. No. 6,547,912, issued to Enlow et al., which teaches an extrusion coating process for making a high transparency protective and decorative film. In a first step, a solventless polymeric material is extrusion coated from an extruder die to form an optically clear first layer on a polyester carrier sheet traveling past the extruder die opening. The extrusion coated first layer is cooled and hardened on the carrier sheet, followed by applying a pigmented second layer to the first layer.

The composite paint coat is transferred to a reinforcing backing sheet, after which the carrier sheet is separated from the paint coat to expose the outer surface of the first layer as a high gloss surface with a high distinctness-of-image, providing a transparent protective outer coat for the pigmented second layer. The pigmented second layer can be solvent cast and dried or extruded and hardened as a separate coating on the first layer. The composite paint coat further can be bonded to a coextruded size coat and semi-rigid plastic substrate panel to form a thermoformable laminate.

Additional techniques are disclosed for producing extruded clear films of exceedingly high optical clarity using a closed air flow transport and HEPA filtration system which removes airborne particles from the resin handling and extrusion process, thereby preventing micron-sized contaminants naturally present from any sources from entering the process and degrading ultimate film quality.

U.S. Pat. No. 5,286,528, issued to Reafler, teaches a protective and decorative sheet material for covering a substrate layer and which includes a flexible carrier film, a paint layer adhered to one surface of the carrier film and containing light reflective flakes, and a transparent polymeric top coat overlaying and adhering to the paint layer and having a thickness of at least about 0.1 millimeter. The sheet material exhibits a substantially unstressed relaxed state and a relaxed area and which is heat softenable to a substantially plastic state in which it is extendable to an extended state having an extended area up to at least 50% greater than the relaxed area.

The paint and topcoat layers exhibit substantially uniform quality and appearance in both the relaxed and extended states. The thick transparent topcoat provides improved retention of gloss and distinctness of image when the sheet material is stretched. A method of preparing the sheet material further includes the step of extruding, in laminar flow, a layer of a cross-linkable transparent topcoat composition over the paint layer.

U.S. Pat. No. 6,206,998, issued to Niazy, teaches a method for making thermoplastic formable sheets laminated with a decorative film, such as one or more layers of glossy clear coat bonded to a layer of pigment containing paint. The method involves providing a thermoplastic formable plastic sheet and applying, on a surface of the plastic sheet, a layer of unsolidified decorative colorant material which forms a decorative first film. Additional steps include curing (if necessary) the decorative material layer to form the adherent first film bonded to the sheet, applying, on the first film, an unsolidified second film for forming a high quality outer surface covering the decorative first film.

Optionally, the decorative sheet may have a first protective layer of thermoformable plastic film removably fixed to the decorative material to protect it from damage during forming of the sheet into a formed part or panel. In auto body trim applications, the formable laminated sheet exhibits a thickness of 0.065″ to 0.30″ and is preferably compression formed with optional thermoforming steps included with, or in place of, compression forming. A second removable protective layer of film may be applied over the first layer to protect against damage prior to compression forming of the sheet.

U.S. Pat. No. 4,810,540, issued to Ellison et al., teaches a flexible decorative sheet material for use in surfacing automobile body panels and the like. The sheet material is characterized by having the appearance of a base coat/clear coat paint finish. The material includes a substantially transparent outer layer, and a pigmented coating on the undersurface of the outer layer which is visible therethrough. The pigmented coating preferably has reflective flakes uniformly distributed therein to import to the sheet material the appearance of a base coat/clear coat paint finish. Also disclosed are shaped articles, which have such sheet materials adhered to one side thereof, and a method for making such sheet materials.

U.S. Pat. No. 6,607,831, issued to Ho et al., teaches a multi-layered article comprising a first layer of a thermoset polyurethane. A second layer of a polymeric composition is bonded to the first layer. The polyurethane has available isocyanate groups prior to the application of the second layer and which is applied onto the first layer in a pre-polymeric or polymeric state wherein the material has carboxyl groups and a cross-linking agent.

Finally, Japanese Patent Publication No. 2003/340948 teaches a lightweight laminated sheet exhibiting high longitudinal and crosswise folding strength. This is obtained by laminating a corrugated fiberboard sheet for combination with the number of corrugation crests of not less than 120 per 30 cm and a corrugation height of not more than 0.6 mm. An attractive decorative printed sheet is applied over the corrugated substrate to complete the assembly.

### SUMMARY OF THE PRESENT INVENTION

The present invention discloses a thin laminate sheet, typically constructed of a thermoplastic-based matrix resin with embedded granules. The laminate sheet is capable of being coiled or rolled to a diameter considerably less than its lesser planar dimension, conveniently packaged, shipped, uncoiled, sectioned and adhered at an end location to a rigid substrate.

The laminate sheet of material exhibits a substantially translucent viewing surface, combined with at least one substantially opaque interior layer. In one embodiment, succeeding layers of substantially transparent, partially opaque and substantially opaque resin based material are coextruded or co-laminated to produce a decorative laminate and which possesses a thickness, in a preferred embodiment, of under 0.100″.

A method of producing a laminate sheet includes the steps of combining volumes of the thermoplastic resin, typically as crushed, ground, or otherwise compounded pellets, along with a volume of crushed granule, which in a preferred embodiment is referenced in inventor's co-pending application Ser. No. 10/737,512 and which features a high aspect ratio (substantially flattened with significantly greater two-dimensional properties in comparison to their respective thickness). Additional volumes of thermoset resin, minerals, glass, rubber and fiber may be admixed with the thermoplastic/granulate recipe in order to modulate the decorative and structural aspects of the laminate sheet material.

Additionally, a method for producing and distributing a flexible laminate material for remote installation includes producing a substantially thin and decorative veneer laminate sheet having a specified planar length and width, coiling the sheet about its least planar dimension and to a diameter lesser than said planar dimension, packaging and transporting the laminate sheet, and uncoiling and adhering the sheet to a rigid substrate.

Additionally, a system for creating a substantially thermoplastic laminate surface is disclosed with a particular textured surface feature that may be refinished or refurbished readily in either a factory or installation venue without damage to the surface texture.

The adhesive may be applied to a backside of the decorative laminate material which may be covered by a peel-away layer. The flexular modulus associated with the decorative laminate further permits it to be applied to, and retained in contact with, an uneven surface associated with the substrate. The materials used in the manufacture of the panel and any granules suspended therein may have a coefficient of thermal expansion and contraction which are similar and only generally differ within 60% relative to one another. An optimal differentiation of 20% is desired in one embodiment. When the larger coefficient is placed in the enumerator and a smaller coefficient is placed in the denominator, the number resulting should be less than 1.6.

Due to the durable, substantially clear hard cap polymer top strata layer, any decorative materials placed into the panel are not necessarily exposed to any abrasion. This is a significant feature of the invention, as un-mineral-filled or lower solid-filled polymers tend to show any scratching or marring of the surface to a much lesser degree. It is this feature that allows certain softer and less durable thermoset resins to function as well as or even better than other more expensive, harder, and ostensibly more durable thermoset polymer formulations.

Certain decorative materials, such as pearl and metallic effects are known to refract light when damaged in such a way as to exacerbate the visual effects of any visible damage or marring of the polymer they are suspended therein. Decorative materials, such as exhibiting any metallic or pearl effects, are not directly contacted by any surface marring or minor scratching of the surface. This is of further significance since, in combination with the outer clear layer being unfilled or less filled with any solids (e.g. minerals), the panel is much less likely to show any damage.

Due to the inventive features of greater impact resistance, the more generally pliable nature of the panel and the use of flexible granules, the panel may be easily trimmed without expert knowledge of working with more brittle prior art laminate panels, which are mostly thermoset in nature. Further, the panel is able to be cut and trimmed with a razor knife, eliminating the need for power tools altogether. The lower tool abrasion and high tensile strength of the resin composition of the panel allows the panel to be trimmed with a router, throwing off large shavings as opposed to fine dust, thereby eliminating or reducing job site airborne contaminants and a potential health hazard source.

Due to the elimination of the brown phenolic resin strata layer from traditional prior art laminate panels, no “brown line” is apparent as in traditionally-fabricated articles as seen in the prior art materials. Due to its thermoplastic composition, the panel is easily thermoformable, further distinguishing from prior art laminates which are not.

Further, the inventive granules from inventor's co-pending application, U.S. Ser. No. 10/737,512, when used in conjunction with the present invention, create a thermoformable material with a solid surface appearance without the prior art problem of visible particle migration post form. Further still, due to the similar coefficient of expansion and contraction of the granules relative to the strata layer they are disposed therein and that of the various strata layers themselves due to the hot bonding of various strata layers within the laminate sheet the material is highly resistant to de-lamination from impact along the edge surfaces. Additionally, the material creates no styrene emissions during manufacture as in prior art solid surface manufacturing processes and conserves materials by 80% (7 lbs. in lieu of 220 lbs.) in consumption or raw materials per sheets of identical square footage.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view illustrating a sheet of a decorative laminate material according to a preferred embodiment of the present invention;

FIG. 2 is a succeeding illustration of the sheet of decorative material coiled to a diameter less than its lesser planar dimension;

FIG. 3 is an enlarged sectional illustration of the plastic laminate material according to a preferred variant and illustrating a first substrate layer and a succeeding topcoat layer exhibiting flat planar granules;

FIG. 4 is a cutaway view taken along line 4-4 of FIG. 3 and further illustrating a substantially transparent top coat layer applied to the laminate material in order to produce a three strata layered material;

FIG. 5 is an exploded partial view of the multi-strata layered material of FIG. 4 and further illustrating the clear cap, semi-transparent (opaque), and fully opaque layers according to the present invention;

FIG. 6 is an illustration in perspective of an installation step according to the present invention and showing the flexible sheet of decorative material adhered to a surface associated with a rigid substrate;

FIG. 7 is a partial side illustration of an arcuate edge configuration application of laminate decorative sheet according to the present invention;

FIG. 8 is a plan view illustration of a pair of sheets of laminate material in a “V” grooved edging application according to the present invention; and

FIG. 9 is a schematic representation of a method of producing and applying a thin, coilable plastic laminate material according to the present invention.

### DETAILED DESCRIPTION OF THE PREFERRED EMBODIMENTS

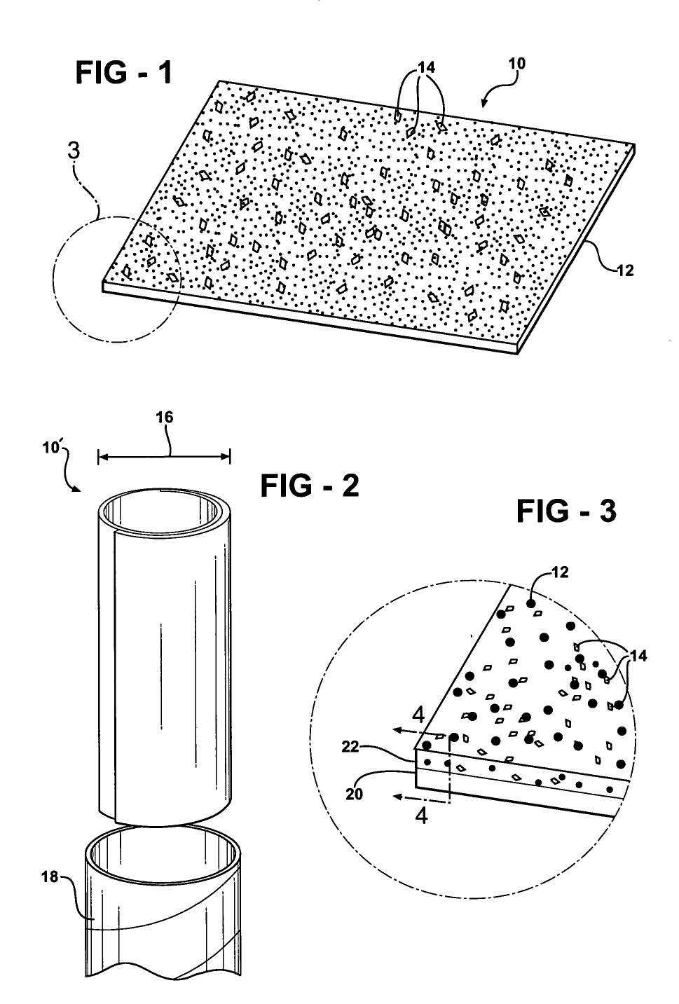

Referring now to FIG. 1, a perspective view is shown at 10 of a sheet of a decorative laminate material according to a preferred embodiment of the present invention. In a preferred embodiment, the decorative veneer laminate is produced in a 4′×8′ sheet, and typically exhibiting a thickness in a range of 1/32″ to ⅛″. Other preferred dimensions include a sheet width of at least 21″ and a length greater than 36″. Preferably, a thickness range of between 0.010″ up to 0.150″ is employed to produce a laminate sheet exhibiting a desired flex modulus, it being understood further that no specific thickness range is required so long as the laminate sheet material thus created exhibits the necessary properties of coilability and breakage/chip resistance.

The laminate sheet is constructed of thermoplastic-based matrix 12, typically provided in pre-compounded and pellet form, combined with a volume of crushed granules 14. The sheet is extruded, according to known manufacturing processes, to its desired and planar length, width and thickness and such that the sheet exhibits at least a substantially transparent viewing surface, revealing the granules. The granules 14 may further be intermixed with additional liquid pigments and/or colorizations to increase the appeal of the decorative laminate thus produced.

The granules are intended to provide a similar flex moduli (elasticity) as compared to the resinous mixture within which the granules are admixed/entrained. Additionally, a coefficient of thermal expansion (CTLE) associated with the selected granules is, in a preferred embodiment, within 60% of a corresponding CTLE associated with the layer of material, e.g. resin, within which it is entrained.

In varying preferred embodiments, granules exhibit high aspect ratios, typically having much greater two-dimensional length and width, and in comparison to very thin thicknesses such as in a range of 0.001″ to 0.008″. In one application, the granules may exhibit an aspect ratio of 2.0 or more between their least planar dimensions and thicknesses. In one application, the granules may include material structure including both natural and synthetic polymers such as mica, silica based materials, and formed crystalline structures. Percentages of granule composition may include 25% by weight of mica or other suitable material, including again mineral, glass, rubber and thermoset resin.

The granules may further include at least one of a mineral and a bio-polymer cellulosic film source. Exemplary cellulosic materials may include those drawn from vegetable, plant, tree, wood, pulp, and chitin (a polysaccharide which forms the hard outer shell of insects, spiders, crustaceans and the like) sources. Visually discernable granules may also be prepared from various biopolymers. As used herein, the term “biopolymer” is defined as polymeric materials derived, at least in part, from plant starch or starches. Suitable biopolymeric materials are resins produced from organic natural materials that provide a chemical hydrocarbon strand or chain similar to those found in thermoplastics. It is contemplated that the biopolymeric resins may contain limited concentrations of petroleum byproducts in significantly lower concentrations than typically found in standard thermoplastic materials. Suitable materials may include, but are not limited to, those used in food packaging, wrapping and biodegradable applications. Suitable materials can be produced by various processes including processes producing regenerated cellulose or rayon derived from various sources including wood pulp, cotton and the like, as well as alginate materials derived from seaweed and materials derived from vegetable protein such as chitin.

The granule surface may further exhibit a metallic finish such as gold, silver, aluminum, brass, iron, and rust. It is also contemplated that at least 20% of the granules, by weight, exhibit less than 0.150″ of their mean planar dimension.

Correspondingly, the thermoplastic resin base, e.g., typically amounting to at least roughly 50% by volume of the laminate recipe, may also be derived from various cellulosic sources (e.g., vegetable, plant, tree, pulp). In the extrusion process for producing the flat planar sheets, additional minor volumes of co-extruded components, such as minerals, thermoset resin, rubber, fibers, and the like may be added to adjust the desired structural and decorative aspects of the laminated sheet.

As further illustrated in FIG. 2, and once produced the laminate sheet, referenced here at 10′, exhibits a flex modulus which permits the sheet to be coiled to a diameter 16 less than its least planar dimension. In a preferred embodiment, the thin laminate sheet is capable of being coiled to diameters such as downwards of 0.4 or even 0.2 in instances of a factor of its lesser planar dimension. For a 4′×8′ planar sheet, this would amount to a coiled dimension of 1.6′. As will be described in further detail throughout the succeeding embodiments, the coiled laminate sheet 10′ is capable of being easily packaged, such as by inserting into a durable (such as corrugated) tube or sleeve 18 for shipment.

A further feature of the coiled laminate sheet is that its flexular modulus is such that the incidence of cracking and chipping of the sheet, and in particular its edges, is minimized. It has further been determined that such coiling imparts no excessive levels or degrees of stress concentrations to the coiled edges of the sheet.

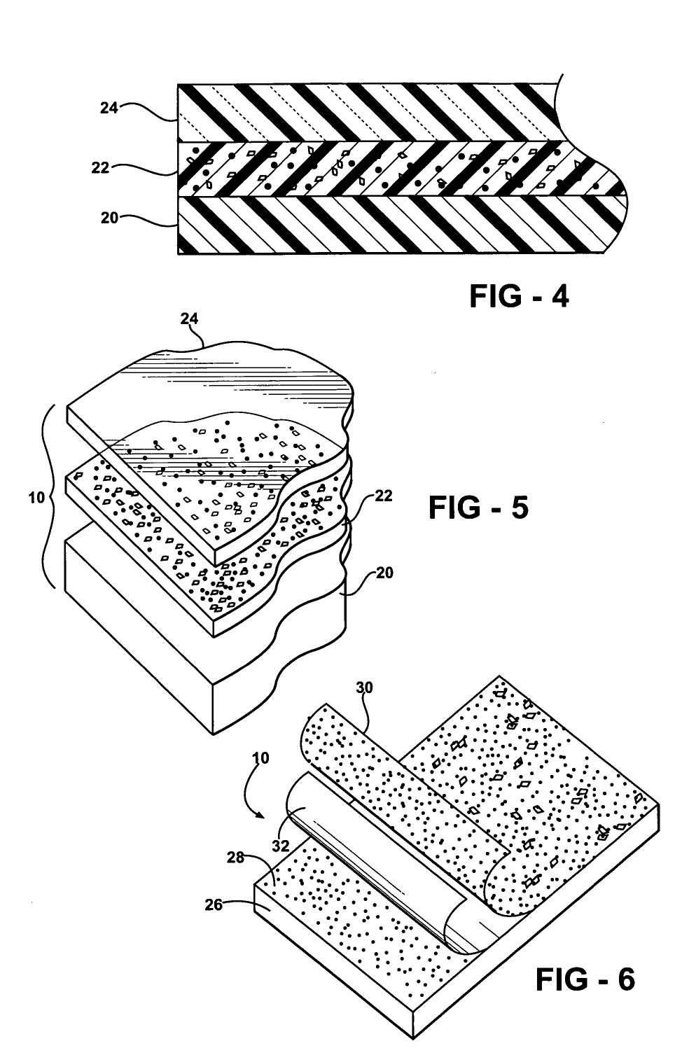

As shown in FIG. 3, an enlarged sectional illustration of the plastic laminate material according to a preferred variant illustrates a first substrate layer 20 and a succeeding topcoat layer 22 exhibiting the flat granules 14. As further referenced in the cutaway view of FIG. 4, a further variant illustrates a substantially transparent top coat 24 applied to the laminate material in order to produce a three strata layered material. Consistent with the earlier description, a resinous base may include at least one layer consisting of at least 40% by weight of a cellulosic material drawn from a group including at least one of vegetable, plant, tree, wood, plant, chitin, and pulp sources.

As further shown in FIG. 5, an exploded partial view of the multi-strata layered material of FIG. 4 illustrates the clear cap 24, semi-transparent (opaque) 22, and fully opaque 20 layers according to the present invention. It is further understood that any reasonable number of coextruded layers can be implemented in the extrusion/coextrusion of the laminate sheet, the preferred embodiments typically exhibiting one, two or three such strata layers. It is further envisioned that the opaque layer may feature a printed geometric pattern and such as may be at least partially viewable from its uppermost visible (top strata) layer.

It is also envisioned that, in a further envisioned embodiment, a flexible laminate sheet material can be produced and which includes a first substantially thin layer exhibiting a length, width and thickness, such a layer including at least 50% by volume a thermoplastic resin. Applied to the first layer, such as in co-extruded or otherwise applied fashion, is a second layer within which is exhibited at least 20% by weight of at least one of a mineral, glass, and thermoset resin.

Without further elaboration, it is also envisioned that nanotechnology extrusion processes may be applied to create the desired resin based layers and which may contain admixed volumes of solid or flowable decorative material. Other manufacturing considerations contemplate reducing an associated coefficient of expansion/contraction to a degree of 30-50% between corresponding raw and finished products. Such an article thus created may further include less than 100% opacity in a main (monolith) layer, as well as a desired change in a given index of refraction between resinous materials corresponding to filler and median layers.

Referring now to FIG. 6, an illustration is shown in perspective of an installation step according to the present invention and showing a flexible sheet of decorative material, such as previously identified at 10, adhered to a surface associated with a rigid substrate 26. Fabrication and application of the laminate sheet typically occurs at a remote location, such as associated with an installer, and typically includes an adhesive or tacky surface applied either to an exposed application surface 28 of the rigid substrate and/or an underside surface 30 of the laminate sheet, and such as which is further covered by a peel-away backing 32.

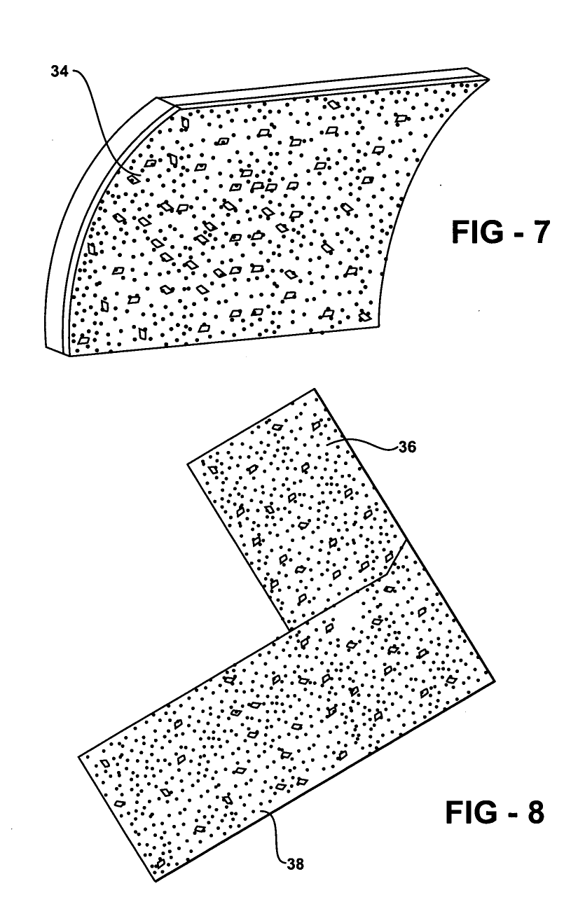

As is further known in the art, the adhesive may be in the form of contact cement or other suitable material which will securely and permanently hold the laminate to the rigid substrate. The adhesive may particularly be of a flexible variety, thereby allowing for some movement between the rigid substrate and the inventive panel itself. The rigid substrate may further include any of a wood, polymer or mineral based (e.g., gypsum) material. FIG. 7 illustrates a partial side view of an arcuate edge configuration application 34 of a laminate decorative sheet applied to an associated substrate material. FIG. 8 further illustrates a plan view of a pair of fabricated sheets 36 and 38 of laminate material in a “V” grooved edging application according to the present invention. Additional applications of flexible laminate include vacuum forming to a desired rigid substrate or applying a thermal rolled radiused edge system.

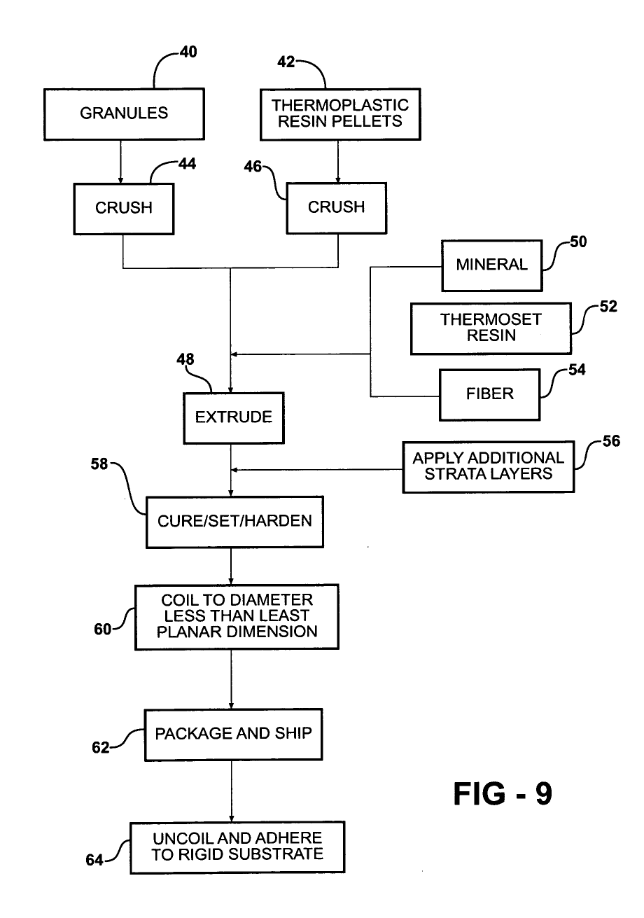

Referring to FIG. 9, a schematic representation is shown of a method of producing and applying a thin, coilable plastic laminate material according to the present invention. In particular, the method includes providing an admixture of granules 40 and thermoplastic resin pellets 42, crushing each, at 44 and 46, and prior to passing the mixture to an extrusion process 48. Optionally, additional volumes of materials including minerals 50, thermoset resin 52 and fiber 54 can be included with the extruded mixture and in order to adjust the decorative and structural aspects of the laminate sheet.

At step 56, additional strata layers can be coextruded, such as in the form of semi-opaque or substantially transparent layers as previously described. At step 58, the extruded sheet thus produced is cured, set and hardened. At step 60, the laminate sheet is coiled about its lesser planar dimension, packaged and shipped at 62 and, finally, at 64 is uncoiled and adhered to a rigid substrate. A method for producing a flexible laminate material, as well as producing and distributing such a remote material for remote installation, is also disclosed and which embodies steps corresponding to the structure discussed above.

An additional variant of the present method further contemplates the steps of producing a substantially thin and decorative veneer laminate sheet having a specified planar length and width, bonding the sheet to a planar substrate material, cutting at least one elongated groove along a rear facing surface of the substrate and into an adhering surface of the laminate, and without penetrating a laminate outer surface, and filling a groove created thereby with an adhesive and collapsing the groove upon itself to create a finished 90° edge. It is also contemplated that multiple elongated “V” grooves may be cut into the back side or front side of the panel with either equal or differing included angles to create various decorative edges and backsplash details. An additional associated method step contemplates texturing a viewing surface of the laminate sheet with a selected pattern of projections and in order to increase a level of light diffusion of the surface.

Additional method steps include cutting a panel into thin ribbons, which are then applied onto a face edging of a countertop surface, such as is generally referenced again in FIG. 7. Sectioning into strips produces greater flexibility, improved resistance to de-lamination, impact, and a lack of an exposable brown coloring existing under a strata layer, which makes for an improved countertop edging system which can be fabricated, bent and otherwise “flexed” in and out of corners associated with a rigid backing application with much greater ease of application. In one specific application, the narrow ribbons may be extruded in a non-planar, or bumpy faux surface, such as mimicking a 1950's era chrome surface. It is also envisioned that a suitable chemical, mechanical or electrical process may be employed to etch a rearmost surface of the sheet formed.

As discussed previously, a unique method step contemplated is to incise or cut a rear facing surface of a thin decorative laminate sheet, such as after the sheet has been applied to a planar substrate material. The incision is carefully made so as not to pierce or penetrate the outer laminate surface. At this point, an elongated groove created by the incision is filled with an adhesive material and collapsed upon itself.

In a specific application according to this embodiment, the groove(s) thus created may be angled in a range with a sum totaling between 42° and 100° and most preferably in a range of 85° and 105° between associated surfaces of the laminate. Additionally, the laminate surface of the material thus created may include the formation of semi-hemispherical projections and to provide an extra decorative effect.

Lesser embodiments of the invention may forgo the flexible advantage to obtain certain cost advantages. This will usually include the substitution of some mineral filler and preclude the laminate sheet from being shipped according to the business model taught herein. The use of this variant, particularly in combination with adherence to a coordinated coefficient of expansion and contraction between the granules and any strata layer they are disposed therein creates a laminateable sheet material with extreme dimensional stability and an attractive variegated appearance of granite and other optical effects, at a greatly reduced cost over prior art chemistries. Further, this variant may be utilized as one strata layer, particularly with a thermoplastic-based strata layer, especially one selected from the following: wood pulp, cellulose, chitin, etc.

Having described my invention, other and additional preferred embodiments will become apparent to those skilled in the art to which it pertains, without deviating from the scope of the appended claims.

1. A flexible laminate material, comprising:
a substantially thin sheet exhibiting a length, width and thickness;
said sheet presenting a substantially viewable surface which reveals a plurality of granules encapsulated within said thickness of said sheet, and said sheet exhibiting a degree of elasticity sufficient to permit said sheet to be coiled to a diameter less than its least planar dimension.

2. The laminate material as described in claim 1, said sheet having a width of at least 21 inches and a length greater than 36 inches.

3. The flexible laminate material as described in claim 1, further comprising said sheet exhibiting a specified shape and being planarly bonded to a rigid substrate.

4. The flexible laminate material as described in claim 1, said sheet exhibiting a specified shape and size and further comprising a thickness range of between 0.010 inches to 0.150 inches.

5. The flexible laminate material as described in claim 1, further comprising an extruded recipe of at least 50%, by volume, of a thermoplastic resinous base, combined with at least one additional volume of granules, thermoset resin, and fibers.

6. The flexible laminate material as described in claim 5, said granules further comprising at least one of a mineral and a cellulosic film source further including at least one vegetable or plant-derived material, and exhibiting a thickness no greater than 0.008 inches.

7. The flexible laminate material as described in claim 1, further comprising said granules having a specified shape and size and exhibiting a metallic finish.

8. The flexible laminate material as described in claim 7, further comprising at least 20% of said granules by weight exhibiting less than 0.150 inches of their mean planar dimension.

9. The flexible laminate material as described in claim 5, further comprising a rearmost surface of said sheet being etched by at least one of chemical, mechanical and electrical arc processes.

10. The flexible laminate material as described in claim 4, said resinous base consisting of at least 25% by weight of a cellulosic material drawn from a group including at least one of vegetable, plant, tree, wood, plant and pulp sources.

11. The flexible laminate material as described in claim 10, said at least one layer exhibiting a specified shape and size and being substantially transparent.

12. The flexible laminate material as described in claim 11, said granules being present in visually differentiable fashion within said layer.

13. The flexible laminate material as described in claim 1, said sheet exhibiting a specified shape and size and further comprising a first substantially transparent layer, a second partially opaque layer and a third substantially opaque layer.

14. The laminate material according to claim 13, said sheet further having an opaque backing layer featuring a printed geometric pattern, said pattern being at least partially viewable from a viewable surface.

15. The flexible laminate material as described in claim 3, said rigid substrate exhibiting a specified shape and size and further comprising at least one of a wood, polymer or mineral based material.

16. The flexible laminate material as described in claim 1, further comprising said granules exhibiting a coefficient of thermal expansion within a range of 60% in comparison to an associated coefficient of said sheet.

17. A flexible laminate sheet material, comprising:
a first substantially thin layer exhibiting a length, width and thickness, said layer comprising at least 50% by volume a thermoplastic resin; and
a second layer applied upon said first layer and comprising at least 20% by weight of at least one of a mineral, glass, and thermoset resin.

18. A laminate sheet material composed of at least two strata layers, at least one specific strata layer comprising at least 25% by weight of a cellulosic material drawn from a group including at least one of vegetable, plant, tree, wood, plant and pulp sources.

19. The laminate sheet according to claim 18, said sheet being substantially thin and having a width of at least 24 inches and a length greater than said width and at least 48 inches in dimension.

20. The laminate sheet according to claim 18, said strata layer having substantially clear optical properties such that any granules disposed therein will be readily visible.

21. The laminate sheet according to claim 18, said specific strata layer having granules disposed therein, said granules having a typical aspect ratio between their least planar dimension and their typical thickness of at least 2.0.

22. The laminate sheet according claim 18, further comprising at least one additional strata layer composed of at least 25% by weight of at least one of mineral, glass, rubber and thermoset resin materials.

23. The material as described in claim 21, further comprising said granules exhibiting a metallic surface thereon.

24. The material as described in claim 21, said granules being selected from at least two visually differentiable color groups.

25. The material as described in claim 21, said granules being selected from at least one of: a thermoplastic resin and a cellulosic resin derived from at least one of vegetable, plant, tree resin, glass and mineral materials.

26. The material described in claim 25, said granules exhibiting at least 25% by weight of a mica material.

27. The material as described in claim 25, further comprising at least 20% of said granules having a greater dimension less than 0.100 inches in size.

28. A method for producing a flexible laminate material comprising the steps of:
combining a volume of a thermoplastic resin with a volume of decorative material; and
extruding said combined volumes of resin and decorative material in a substantially thin sheet exhibiting a desired length, width and thickness and with a specified modulus of flexibility.

29. The method as described in claim 28, further comprising the step of coiling said sheet about its least planar dimension and to a diameter lesser than said planar dimension.

30. The method as described in claim 28, further comprising the step of contacting at least one substantially polymeric top coat layer to said extruded sheet.

31. The method as described in claim 28, further comprising the step of crushing and pre-mixing a plurality of thermoplastic resin pellets with said decorative material prior to extruding.

32. The method as described in claim 28, further comprising adding a volume of at least one of a mineral, thermoset resin and fiber and glass to said combined thermoplastic resin and granules.

33. The method as described in claim 28, further comprising the step of contacting a first substantially transparent layer, a second partially opaque layer.

34. The method as described in claim 28, further comprising the step of adhering an underside surface of said sheet to a rigid substrate.

35. The method as described in claim 28, further comprising the step of producing said sheet in a thickness range of between 0.010 inches to 0.100 inches.

36. A method for producing and distributing a flexible laminate material for remote installation, comprising the steps of:
producing a substantially thin and decorative veneer laminate sheet having a specified planar length and width;
coiling said sheet about its least planer dimension and to a diameter lesser than said planar dimension;
packaging and transporting said laminate sheet; and
uncoiling and adhering said sheet to a rigid substrate.

37. The method as described in claim 36, further comprising the step of applying an adhesive to a backside of said sheet, a peel-away layer revealing said adhesive surface.

38. The method as described in claim 36, further comprising the step of bending said sheet in the process of adhering said sheet to an uneven substrate.

39. The method as described in claim 36 including the further step of cutting the panel into narrow ribbons at least 1 inch in width.

40. The method as described in claim 39 further comprising the step of adhering said narrow ribbons of said panel onto a face edging of a countertop surface.

41. The method as described in claim 39, further comprising the step of extruding said narrow ribbons into a faux “bumpy” surface face including at least a chrome material.

42. The method as described in claim 36, further comprising the step of blending at least one of a plurality of decorative and colorized pigments along with a selected quantity of compounded granulate.

43. A flexible laminate material, comprising:
a substantially thin sheet exhibiting a length, width and thickness, said sheet presenting a substantially viewable surface comprising a decoratively pigmented strata layer bonded over a substantially opaque rear planar layer; and
said sheet exhibiting a degree of elasticity sufficient to permit said sheet to be coiled to a diameter less than its least planar dimension.

44. The flexible laminate material as described in claim 43, further comprising a substantially clear polymer layer bonded to said viewable surface.

45. The flexible laminate material as described in claim 43, said sheet exhibiting a specified shape and size and being coiled to a diameter less than its least planar dimension.

46. A method for producing and installing a flexible laminate material, comprising the steps of:
producing a substantially thin and decorative veneer laminate sheet having a specified planar length and width;
bonding said sheet to a planar substrate material;
cutting at least one elongated groove along a rear facing surface of said substrate and into an adhering surface of said laminate, and without penetrating a laminate outer surface; and
filling a groove created thereby with an adhesive and collapsing said groove upon itself.

47. The method as described in claim 46, further comprising the step of angling said groove in a range of between associated surfaces of said laminate.

48. The method according to claim 46, further comprising the step of texturing a viewing surface of said laminate sheet with a selected pattern of projections and in order to increase a level of light diffusion of said surface.

49. The method as described in claim 48, further comprising forming the step of said projections in a substantially semi-hemispherical configuration.

50. A polymeric laminate panel comprising at least one substantially thermoplastic-based strata layer; one substantially clear layer applied over said strata layer; at least one layer with visually differentiable particles suspended therein; and at least one layer with at least 20% by weight of at least one of a glass, rubber, wood pulp, thermoset resin and mineral material.

51. A substantially planar sheet of laminateable plastic comprising at least 51% by volume of a thermoplastic resin, said sheet featuring a raised textured viewable surface.

52. The sheet according to claim 51, further comprising a viewable surface reconditioned in a randomly circular motion.

53. The sheet according to claim 52, further comprising a plurality of protrusions formed in said viewable surface by said reconditioning, and employing at least one of an abrasive paste applied by a three-dimensional cushioned pad, a three-dimensional abrasive pad, steel wool, and a petroleum-based liquid.
